(19) United States
(12) Patent Application Publication
(10) Pub. No.: US 2024/0182311 A1
(43) Pub. Date: Jun. 6, 2024

(54) SYSTEMS AND METHODS FOR MANUFACTURING AN AEROGEL

(71) Applicants: Dishank Patel, Lawrenceville, GA (US); Dhaivil Patel, Lawrenceville, GA (US)

(72) Inventors: Dishank Patel, Lawrenceville, GA (US); Dhaivil Patel, Lawrenceville, GA (US)

(21) Appl. No.: 18/286,827

(22) PCT Filed: Apr. 15, 2022
(86) PCT No.: PCT/US22/25066

§ 371 Date: Oct. 13, 2023

Related U.S. Application Data
(60) Provisional application No. 63/175,413, filed on Apr. 15, 2021.
(60) Provisional application No. 63/175,439, filed on Apr. 15, 2021.

(51) Int. Cl. C01B 33/143; C01B 33/158

(52) U.S. Cl. CPC C01B 33/1435; C01B 33/1585

(57) ABSTRACT

An exemplary embodiment of the present disclosure provides a method for manufacturing an aerogel. The method may include mixing a silicate salt with a solution to obtain a sol-gel. The method may include conditioning the sol-gel with one or more abradants to obtain an aerogel product.

### CROSS-REFERENCE TO RELATED APPLICATIONS

This application is a national stage application of International Patent Application No. PCT/US22/25066, filed on Apr. 15, 2022, which claims the benefit of U.S. Provisional Application Ser. No. 63/175,439, filed on 15 Apr. 2021, and U.S. Provisional Application Ser. No. 63/175,413, filed on 15 Apr. 2021, both of which are incorporated herein by reference in their entirety as if fully set forth below.

### FIELD OF THE DISCLOSURE

The various embodiments of the present disclosure relate generally to systems and methods for continuous flow production of aerogels, and more particularly to systems and methods using ion exchange to induce hydrolysis followed by subsequent gelation of materials under ambient pressures.

### BACKGROUND

Aerogels can be described as dried gels that retain, at least in part, their porous texture after drying. Current production of aerogels is based on changing the pressure of the system from ambient to high pressures (super-critical drying) or low pressures (sub-critical drying). These techniques allow the liquid component of the gel to be slowly dried off without causing the solid matrix of the gel to collapse from capillary action and pore collapse. Aerogels have a three-dimensional porous solid network that contains air pockets, allowing the structure to be very strong while almost weightless. These structures also function as great thermal and conductive insulators as they are mostly composed of insulating gas within the microstructure that prevents net gas movement.

Xerogels and alcogels are sol-gels that are dried under pressurized conditions, which often leads to shrinkage and cracking due to differential capillary pressure and pore collapse. For these gels, the shrinkage and cracking make it difficult to obtain low-density materials. These issues, the excessive time required to dry aerogels, and the high cost of raw materials used in current practices, have held back aerogel production.

### BRIEF SUMMARY

The present disclosure relates to systems and methods for manufacturing aerogels. An exemplary embodiment of the present disclosure provides a method for manufacturing an aerogel. The method may include mixing a silicate salt, such as potassium silicate or sodium silicate, with a solution, such as water, to obtain a sol-gel. The method may further include conditioning the sol-gel with one or more abradants (e.g., unreactive and/or abrasive materials) to obtain an aerogel product.

In some embodiments disclosed herein, the method may include mixing the sol-gel with an ion exchange resin configured to convert the silicate salt into silicic acid.

In some embodiments disclosed herein, the method may include mixing the sol-gel with a first catalyst and a second catalyst, the first and second catalysts being configured to neutralize to obtain a water product, and to induce gelation. In some embodiments, the first catalyst may include an acid catalyst while the second catalyst may include a base catalyst, or vice versa.

In some embodiments disclosed herein, the method may include mixing the sol-gel with an organic solvent, such as hexane, to obtain a superhydrophobic aerogel product.

In some embodiments disclosed herein, the method may include heating the sol-gel in a fluidized drying chamber at ambient pressure, and evaporating any remaining solution to produce a dried aerogel product.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a method for manufacturing an aerogel, in accordance with an exemplary embodiment of the present invention.

FIG. 2 provides a method for manufacturing an aerogel, in accordance with an exemplary embodiment of the present invention.

FIG. 3 provides a method for manufacturing an aerogel, in accordance with an exemplary embodiment of the present invention.

FIG. 4 provides a method for manufacturing an aerogel, in accordance with an exemplary embodiment of the present invention.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Suitable aerogel material compositions may include, for example, silica, metal and metalloid oxides, metal chalcogenides, metals and metalloids, organic polymers, biopolymers, amorphous carbon, graphitic carbon, diamond, and discrete nanoscale objects such as carbon nanotubes, boron nitride nanotubes, viruses, semiconducting quantum dots, graphene, or combinations thereof. Metalloids may include boron, silicon, germanium, arsenic, antimony, tellurium, and polonium. Metals may include lithium, sodium, potassium, rubidium, cesium, francium, beryllium, magnesium, calcium, strontium, barium, radium, aluminum, scandium, titanium, vanadium, chromium, manganese, iron, cobalt, nickel, copper, zinc, gallium, yttrium, zirconium, niobium, molybdenum, technetium, ruthenium, rhodium, palladium, silver, cadmium, indium, tin, hafnium, tantalum, tungsten, rhenium, osmium, iridium, platinum, gold, mercury, thallium, lead, bismuth, and combinations thereof.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±20% of the recited value, e.g. “about 90%” may refer to the range of values from 71% to 99%.

Aerogels may be fabricated by removing the liquid from a gel in a way that preserves both the porosity and integrity of the gel's intricate nanostructured solid network. However, for most gel materials, if the liquid in the gel is evaporated under non-ambient pressure, capillary stresses will arise as the vapor-liquid interface recedes into or from the gel, causing the gel's solid network to shrink or pull inwards on itself and collapse. The resulting material is a dry, comparatively dense, low-porosity (generally less than 10% by volume) material that is often referred to as a xerogel material, or solid formed from the gel by drying with unhindered shrinkage. Additionally, when a gel shrinks from capillary collapse, for many gel formulations, functional groups lining the struts of the gel backbone (e.g., often hydroxyl or other polar groups) may have a tendency to stick to each other through hydrogen bonding and/or may react to form a covalent bond (e.g., in the case of hydroxyls to form an oxygen bridge by water condensation, in the case of isocyanates to form a urea, uretdione, biuret, urethane, or other bond), causing irreversible shrinkage of the gel material.

The present disclosure addresses the concerns raised above in providing materials and methods for making aerogels that avoid drying at non-ambient pressures (e.g., super-critical or sub-critical pressures). Since capillary stresses are a source of collapse when the solvent in a gel is evaporated under non-ambient pressures, carefully balancing the modulus of the gel backbone against the magnitude of capillary stress incurred in principle, and conducting such balancing at ambient pressures, would allow for solvent to be removed from a gel without causing substantial collapse.

The present invention is directed to systems and methods for precisely creating a wide array of different types of aerogels at a much faster rate while reducing final shrinkage by introducing increased entropy into the system rather than pressure. That is, the disclosed systems and methods provide for mixing the aerogel with abradants, or unreactive and/or abrasive materials, (e.g., glass, ceramic, or metallic beads) which can assist in creating localized torsional forces. The aerogel/abradant mixture may then be dried in a semi-packed fluidized chamber. Accordingly, the aerogel may be broken into smaller particulates that remain in constant motion throughout the drying process providing increased resistance to shrinkages by creating a pseudo fluidic drying environment in which macro-forces are neutralized, and nano-forces can overcome capillary and evaporative forces. Specifically, the present invention is directed to a system and method for producing aerogels in a continuous flow process utilizing ambient pressure drying through a fluidized system by way of inducing ionic neutralizations.

The present invention utilizes a silicate salt including a cation and an anion, in which the anion has a large amount of chemical reactive bonds that can be made to induce polymerization or gelatinous crystallization. The systems and methods disclosed herein provide for ion exchange of the cation (e.g., for hydrogen) to allow for a larger surface area to support crosslinking via acidic and basic ion neutralization. This may be done through any standard ion exchange system which can include, for example, chemical resins, synthetic (e.g., Amberlite™), organic, and mechanical processes. Using a crosslinking chemical catalyst base derived directly from the anion chemical group, the varying ionized anions may be reacted to create a macro gelatinous structure. Based on the crosslinking chemical catalyst base derived from the anion, the catalyst base may provide a lever in which to selectively engineer different properties, such as hydrophobicity, without extra processing required.

Alongside the catalyst base, an acidic reagent can be used to help neutralize and speed up the process. The process by which the crosslinking happens is specifically engineered to induce a selective ion neutralization in which the ionized anion and the free floating basic and acidic ions can be converted into water. Since the crosslinker chemical catalyst can be derived from the anion (e.g., as its conjugate acid), the force to repulse shrinkage due to evaporative or capillary action is increased, such that the pores remain larger. In addition, since the ions may be linked in much smaller groups of molecules, the shrinkage can be kept down to a minimum while achieving extremely quick drying and conversion from gels to aerogels. After the crosslinking process, a large molecule from an organic solvent (e.g., water to hexane) may be added to the gel to tune the properties of the resulting aerogel, or alternatively, to force solidifying of the gelatinous bonds.

Depending on composition, aerogel materials may exhibit certain properties, such as transparency, high-temperature stability, hydrophobicity, hydrophilicity, electrical conductivity, and/or non-flammability. Such properties may make aerogel materials desirable for various applications, such as insulation, cushioning (e.g., in composites, foams, etc.), or providing barriers in filtration systems.

In addition to the applications discussed above, the aerogels disclosed in this invention may be used in systems and methods for impregnation of other materials, such as wood or other lignocellulosic materials. A wood product may be pressure treated, along with the aerogel particles disclosed herein, to produce superhydrophobic, mold resistant, pest resistant, and/or rot resistant wood. In such applications, a wood product may be placed and sealed inside a vessel, along with one or more of the aerogels disclosed herein, for example those having a particulate size of under 1 micrometer. A vacuum may be pulled, e.g., to under 200 millitorr, to allow for the wood cells to expand and remove any air trapped inside. The expanding wood may create a negative pressure, allowing the aerogel particles to seep inside the wood pores. The wood may be left to expand (e.g., for over one hour) while the aerogel particles seep into the pores. The pressure may then be released to atmospheric pressure, thereby instantly providing an approximately 15-psi negative pressure to compress the wood. The wood may then be removed from the vessel and may have hydrophobic properties even on its internal sides after cutting and/or shaping due to the impregnated aerogel particles. The wood may not require drying or curing after such treatment and may not leech harmful metal ions into the environment.

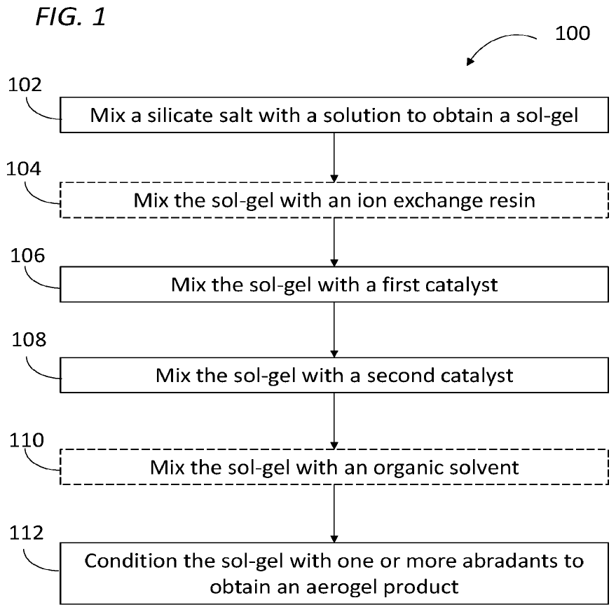

Reference will now be made in detail to exemplary embodiments of the disclosed technology, examples of which are illustrated in FIGS. 1-4, and disclosed herein. Wherever convenient, the same reference numbers will be used throughout the drawings to refer to the same or like parts.

As shown in FIG. 1, an exemplary embodiment of the present invention provides a method 100 for manufacturing an aerogel.

In block 102, a silicate salt may be mixed with a solution to obtain a sol-gel. In some embodiments, the silicate salt may include potassium silicate, sodium silicate, aluminum silicate, calcium silicate, zirconium silicate, cobalt(II) orthosilicate, iron(II) orthosilicate, lithium orthosilicate, or combinations thereof. The solution may include a suitable aqueous solution for dissolving the silicate salt, such as, for example, water, a buffer, a saline solution and the like. In some embodiments, the silicate salt may be diluted in the solution to a concentration of approximately 3-7 weight percent (wt %). This concentration helps to ensure a covalent bond network may be formed within the resulting three-dimensional network solid of the sol-gel. If the concentration is too high or low, however, the distance between nodes within the resulting solid may be too far apart for covalent bonding to have a large enough effect to create such a network. For example, if the concentration of the silicate salt is too high, silicon dioxide may be generated and precipitate out of solution. If, on the other hand, the concentration of the silicate salt is too low, the pore size of the resulting aerogel would be too small, impacting the density, as further discussed below. In such situation, rather than the aerogel including an amorphous tunnel-like structure, as desired, the low density aerogel may generate pseudo flakes, including a more crystalline structure.

In block 104, the sol-gel may optionally be mixed with an ion exchange resin, such as AmberLite™. The ion exchange resin may be configured to convert the silicate salt, or at least a portion thereof, into silicic acid through a hydrogen exchange process. For example, when the silicate salt includes potassium silicate, as discussed above, at least a portion of the potassium may be exchanged with hydrogen such that silicic acid is produced. As another example, when the silicate salt includes sodium silicate, as discussed above, at least a portion of the sodium may be exchanged with hydrogen such that silicic acid is produced. The same would apply for any cation component of the silicate salt. The addition of the added hydrogen helps to increase the total number of protons in the solution, bringing the pH under 7, allowing for a larger surface area of the now diluted silicate salt to support crosslinking via acidic and basic ion neutralization, as further discussed below.

In some embodiments, the sol-gel may not be mixed with an ion exchange resin, and the process may instead proceed to the addition of a first and second catalyst, as further discussed below. In such embodiments where no ion exchange resin is used, the mixing speed applied throughout the aerogel manufacturing process may be faster than that applied to a solution including the ion exchange resin. For example, when using an ion exchange resin, a mixing speed of approximately 300 revolutions per minute (rpm) may be applied, while when not using an ion exchange resin, a mixing speed of greater than 300 rpm may be applied (e.g., approximately 300-350 rpm, approximately 350-400 rpm, approximately 400-450 rpm, approximately 450-500 rpm, approximately 500-550 rpm, approximately 550-600 rpm, approximately 600-650 rpm, or any range of speeds in between e.g., approximately 427-531 rpm).

In block 106, the sol-gel may be mixed with a first catalyst. In such embodiments where the diluted silicate salt is first mixed with an ion exchange resin, as discussed above, the first catalyst may include an acidic catalyst, such as a protic acid (e.g., nitric acid, sulfuric acid, sulfurous acid, phosphoric acid, carbonic acid, hydrochloric acid, and the like). The acidic catalyst may have a concentration of approximately 0.1 molarity (M). Providing a lower concentration of acid catalyst helps to avoid any precipitants, such as silicon dioxide, from forming and falling out of solution. The addition of the acidic catalyst solution may help to lower and finely adjust the pH of the diluted silicate salt solution within a range of about 1.5 to about 2.5 (e.g., to a pH of about 1.6 to about 2.4, about 1.7 to about 2.3, about 1.8 to about 2.2, about 1.9 to about 2.1, about 2.0 to about 2.0, and any range in between, e.g., from about 1.62 to about 2.45). In some embodiments, where the addition of the acidic catalyst may increase the temperature of the utilized mixing reactor or other vessel, a cooling system (e.g., a vessel jacket, ice bath, etc.) may be utilized to ensure the internal temperature of the system does not rise to a point of potential burning of the sol-gel (e.g., higher than approximately 250° C.), as further discussed below.

In such embodiments where the diluted silicate salt is not first mixed with an ion exchange resin, as discussed above, the first catalyst may instead include a base, such as hexamethyldisilizane (HMDS), or another organosilane compound, such as bis(trimethylsilyl)amine (another name for HMDS), tris(trimethylsilyl)silane, tetraethoxysilane, methyltrimethoxysilane, propyltriethoxysilane, phenyltriethoxysilane, vinyltriethoxysilane, aminopropyltriethoxysilane, aminopropyltrimethoxysilane, mercaptopropyltriethoxysilane, cyanoethyltriethoxysilane, dimethyldiethoxysilane, and the like. Adding the base catalyst first in a process in which no ion exchange resin was first used, as discussed above, helps to form a covalent bond network to begin the gelation process.

In block 108, the sol-gel may be mixed with a second catalyst. In such embodiments where the diluted silicate salt is first mixed with an ion exchange resin, as discussed above, the second catalyst may include a basic catalyst, such as HMDS or another organosilane compound, as discussed above. The basic catalyst may have a concentration of approximately 0.1 M. The mixing of the second (basic) catalyst following the first (acidic) catalyst helps to produce a neutral gelatinous network solution with a pH of approximately 6 to 7.5 (e.g., to a pH of about 6.1 to about 7.4, about 6.2 to about 7.3, about 6.3 to about 7.2, about 6.4 to about 7.1, about 6.5 to about 7.0, about 6.6 to about 6.9, about 6.7 to about 6.7, and any range in between, e.g., from about 6.52 to about 7.37).

In such embodiments where the diluted silicate salt is not first mixed with an ion exchange resin, as discussed above, the second catalyst may instead include an acidic catalyst, such as those described above. In such embodiments, the mixing of the second (acidic) catalyst following the first (basic) catalyst may not fully neutralize the overall solution. As such, the first (basic) catalyst may need to be mixed into the solution for a second time to further increase the pH. The second (acidic) catalyst may then need to be mixed into the solution for a second time to further neutralize the overall solution to a pH of approximately 6 to 7.5 (e.g., to a pH of about 6.1 to about 7.4, about 6.2 to about 7.3, about 6.3 to about 7.2, about 6.4 to about 7.1, about 6.5 to about 7.0, about 6.6 to about 6.9, about 6.7 to about 6.7, and any range in between, e.g., from about 6.52 to about 7.37). This second mixing of both catalysts, and resulting second pH swing, helps to produce the neutral gelatinous network solution with a pH of approximately 6 to 7.5 (e.g., to a pH of about 6.1 to about 7.4, about 6.2 to about 7.3, about 6.3 to about 7.2, about 6.4 to about 7.1, about 6.5 to about 7.0, about 6.6 to about 6.9, about 6.7 to about 6.7, and any range in between, e.g., from about 6.52 to about 7.37).

In block 110, the sol-gel, now a neutral gelatinous network solution, may be mixed with an organic solvent having a high molecular weight, such as hexane, heptane, octane, nonane, decane, 1,4-dioxane, ethyl acetate, methyl t-butyl ether, 1,2-dimethoxyethane, glycerin, toluene, 1-2-dichloroethane, N-methyl-2-pyrrolidinone, triethylamine, diethylene glycol, xylene (o-, m-, or p-), chlorobenzene, chloroform, diglyme (diethylene glycol dimethyl ether), hexamethylphosphorous triamide, hexamethylphosphoramide, and the like. This step provides for a solvent exchange of water, contained within the sol-gel, to the heavier organic solvent, aiding in the eventual formation of a superhydrophobic aerogel. In practice, the sol-gel may be submerged in the organic solvent, e.g., hexane, such that the water and hexane separate into defined layers, and the water layer may be removed. Alternatively, when a hydrophilic aerogel is desired, the sol-gel may not be mixed with an organic solvent but may instead be transitioned directly into the drying process, as further discussed below:

In block 112, the sol-gel may be conditioned with one or more abradants to obtain an aerogel product. The one or more abradants may include a suitable unreactive and/or abrasive material, such as glass, ceramic, or metallic beads, that may be used to break up the sol-gel into small particulates as it is being dried. The one or more abradants may have particle sizes ranging from about 1.0 millimeters (mm) to about 50 mm (˜2 inches) in diameter (e.g., from about 5 mm to about 15 mm, from about 15 mm to about 20 mm, from about 20 mm to about 25 mm, from about 25 mm to about 30 mm, from about 30 mm to about 35 mm, from about 35 mm to about 40 mm, from about 40 mm to about 45 mm, from about 45 mm to about 50 mm, or any diameter range in between, e.g., from about 2.8 mm to about 32 mm). The sol-gel particulates may have a particle size as low as approximately 100.0 micrometers (μm) (e.g., as low as 90 μm, as low as 80 μm, as low as 70 μm, as low as 60 μm, as low as 50 μm, as low as 40 μm, as low as 30 μm, as low as 20 μm, as low as 10 μm, as low as 5 μm, as low as 3 μm, as low as 2 μm, or any size in between, e.g., as low as 6.8 μm). The sol-gel and abradants may be placed in a semi-packed fluidized chamber, operating at ambient pressure, such that the abradants help to reduce the particle size of the sol-gel to allow for easier fluidization of the semi-packed system as it is being continuously circulated and dried. The abradants may make up approximately 5% to 15% of the total internal volume of the fluidized chamber, and approximately 30% of the sol-gel volume within the fluidized chamber.

In some embodiments, a hot air stream may be supplied into the fluidized chamber, helping to circulate the sol-gel and abradants within the chamber. The hot air stream may vary in temperature, not to exceed approximately 250° C. For instance, the hot air stream may range from about 30° ° C. to about 250° ° C. (e.g., from about 30° C. to about 40° C., from about 40° C. to about 50° C., from about 50° ° C. to about 60° C., from about 60° ° C. to about 70° ° C., from about 70° C. to about 80° C., from about 80° ° C. to about 90° C., from about 90° ° C. to about 100° C., from about 100° C. to about 110° C., from about 110° ° C. to about 120° C., from about 130° ° C. to about 140° ° C., from about 140° ° C. to about 150° C., from about 150° C. to about 160° C., from about 160° C. to about 170° ° C., from about 170° ° C. to about 180° C., from about 180° ° C. to about 190° C., from about 190° C. to about 200° C., from about 200° ° C. to about 210° C., from about 210° C. to about 220° C., from about 230° ° C. to about 240° C., from about 240° ° C. to about 250° ° C., or any range in between, e.g., from about 67° C. to about 224° C.).

Throughout this heating process, remaining solution contained with the fluidized chamber may evaporate, during which time the density of the remaining sol-gel particles may decrease, and dried aerogel particles may be produced. Throughout the drying process, the sol-gel particles may have a density of about 1.7 to about 2.2 grams per cubic centimeters (g/cm³) (e.g., from about 1.8 g/cm³ to about 2.1 g/cm³, from about 1.9 g/cm³ to about 2.0 g/cm³, from about 2.0 g/cm³ to about 2.0 g/cm³, or any range in between, e.g., 1.82 g/cm³ to about 2.11 g/cm³). Once fluidization is complete, the density of the resulting aerogel product may fall below approximately 1.5 g/cm³ (e.g., below approximately 1.4 g/cm³, below approximately 1.3 g/cm³, below approximately 1.2 g/cm³, below approximately 1.1 g/cm³, below approximately 1 g/cm³, below approximately 0.9 g/cm³, below approximately 0.8 g/cm³, below approximately 0.7 g/cm³, below approximately 0.5 g/cm³, below approximately 0.5 g/cm³, below approximately 0.4 g/cm³, below approximately 0.3 g/cm³, below approximately 0.2 g/cm³, below approximately 0.15 g/cm³, below approximately 0.1 g/cm³, or any density value in between, e.g. below approximately 0.865 g/cm³). In some embodiments, the density of the resulting aerogel product may fall below approximately 0.15 g/cm³.

In some embodiments, fluidization of the sol-gel, as discussed above (block 112), may not be used. In such embodiments, pore size of the resulting aerogel product may shrink to some extent, but may still help to prevent pore collapse. That is, when the sol-gel is left to air dry or is dried using another form of non-pressure drying, the final volume of the dried aerogel product may range from about 40% to about 60% of the initial volume of the sol-gel before drying. Further, a lack of fluidization may result in an increased density of the resulting aerogel particles (e.g., about 0.4 g/cm³ compared to about 0.15 g/cm³ with fluidization), and the overall drying process may take a significantly longer amount of time (e.g., approximately four days without fluidization versus approximately 30 minutes with fluidization).

In some embodiments, the same vessel or chamber may be used for both sol-gel formation and fluidization. In other embodiments, a first vessel, such as a reactor, may be used for the sol-gel formation process (e.g., mixing of the silicate salt with the solution to obtain the sol-gel, and mixing of the sol-gel with the ion exchange resin and/or the first and second catalysts), while a second vessel, such as a fluidized chamber (e.g., 5 gallons, 250 gallons, etc.), may be used for the fluidization process. In either case, the vessel or chamber used for fluidization may be equipped with suitable mixing equipment such as a sprinkler or nozzle system, and/or an outlet stream such that the dried aerogel particles may be pulled out of the chamber, such as for downstream processing or packaging.

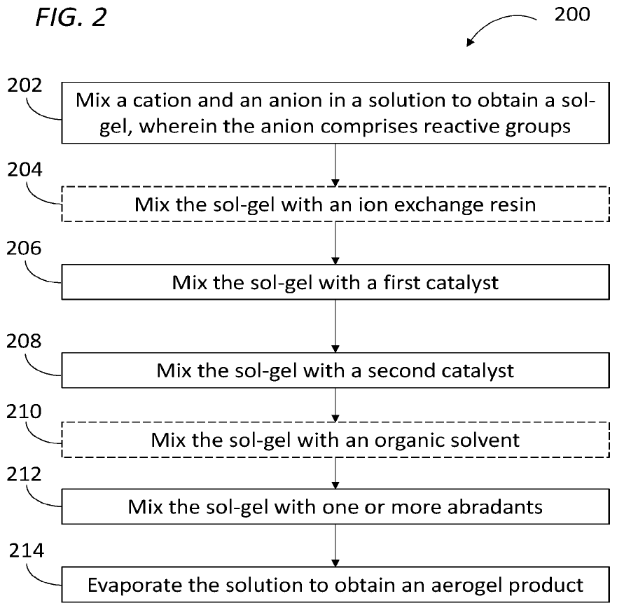

As shown in FIG. 2, an exemplary embodiment of the present invention provides a method 200 for manufacturing an aerogel. The method 200 of FIG. 2 is similar to method 100 of FIG. 1, except that method 200 may include blocks 202 and 214. The descriptions of blocks 204, 206, 208, 210, and 212 of method 200 may be the same as or similar to the respective descriptions of blocks 104, 106, 108, 110, and 112 of method 100, and as such are not repeated herein for brevity. However, blocks 202 and 214 are described below.

In block 202, a cation and an anion may be mixed in a solution (e.g., water) to obtain a sol-gel, wherein the anion comprises reactive groups. In some embodiments, the cation may include, for example, potassium or sodium, while the anion may include, for example, silicate. The anion may include reactive groups or bonds that can be configured to induce gelatinous crystallization, as discussed herein.

In block 214, the solution may be evaporated to obtain an aerogel product. As discussed herein, any solution remaining in the semi-packed fluidized chamber may be evaporated off, and with the help of a hot air stream, leaving behind the dried aerogel particles.

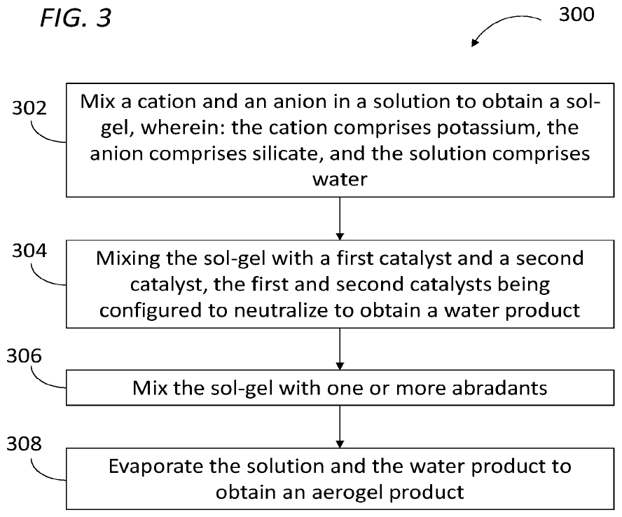

As shown in FIG. 3, an exemplary embodiment of the present invention provides a method 300 for manufacturing an aerogel. The method 300 of FIG. 3 is similar to method 200 of FIG. 2. The descriptions of blocks 302, 304, 306, and 308 of method 300 may be the same as or similar to the respective descriptions of block 202, 206/208, 212, and 214 of method 200, and as such are not repeated herein for brevity.

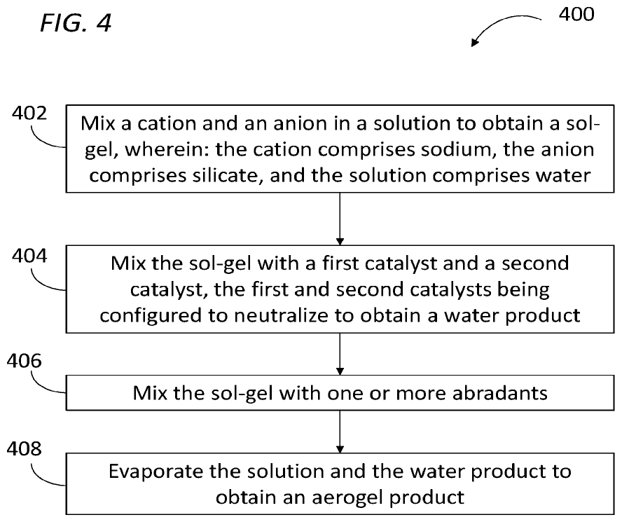

As shown in FIG. 4, an exemplary embodiment of the present invention provides a method 400 for manufacturing an aerogel. The method 400 of FIG. 4 is similar to method 200 of FIG. 2. The descriptions of blocks 402, 404, 406, and 408 of method 400 may be the same as or similar to the respective descriptions of block 202, 206/208, 212, and 214 of method 200, and as such are not repeated herein for brevity.

The present invention is hence directed to semi-continuous production of aerogels utilizing batch formation of gelatinous particles and continuous fluidized drying. The formation of gelatinous particulates may be generated through ion exchange and acid/base co-precursor methods. These particulates may be ground and mixed with unreactive and/or abrasive materials for easier fluidized drying and reduction of maximum particle size.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A process comprising:
mixing a silicate salt with a solution to obtain a sol-gel; and
conditioning the sol-gel with one or more abradants to obtain an aerogel product.

2. The process of claim 1, wherein the silicate salt comprises potassium silicate, sodium silicate, aluminum silicate, calcium silicate, zirconium silicate, cobalt(II) orthosilicate, iron(II) orthosilicate, lithium orthosilicate, or combinations thereof.

3. The process of claim 1, wherein the solution comprises water.

4. The process of claim 1, further comprising mixing the sol-gel with an ion exchange resin configured to convert the silicate salt into silicic acid.

5. The process of claim 4, further comprising mixing the sol-gel with a first catalyst.

6. The process of claim 5, wherein the first catalyst comprises nitric acid, sulfuric acid, sulfurous acid, phosphoric acid, carbonic acid, hydrochloric acid, or combinations thereof.

7. The process of claim 5, further comprising mixing the sol-gel with a second catalyst.

8. The process of claim 7, wherein the second catalyst is configured to crosslink with the silicate salt to obtain a gelatinous network structure.

9. The process of claim 7, wherein the first and second catalysts are configured to neutralize the solution to obtain a water product.

10. The process of claim 7, wherein the mixing of the sol-gel with the first catalyst occurs before the mixing of the sol-gel with the second catalyst.

11. The process of claim 7, wherein the second catalyst comprises an organosilane compound.

12. The process of claim 11, wherein the second catalyst comprises bis(trimethylsilyl)amine, tris(trimethylsilyl)silane, tetraethoxysilane, methyltrimethoxysilane, propyltriethoxysilane, phenyltriethoxysilane, vinyltriethoxysilane, aminopropyltriethoxysilane, aminopropyltrimethoxysilane, mercaptopropyltriethoxysilane, cyanoethyltriethoxysilane, dimethyldiethoxysilane, or combinations thereof.

13. The process of claim 12, further comprising exchanging the solution with an organic solvent.

14. The process of claim 13, wherein the organic solvent comprises hexane, heptane, octane, nonane, decane, 1,4-dioxane, ethyl acetate, methyl t-butyl ether, 1,2-dimethoxyethane, glycerin, toluene, 1-2-dichloroethane, N-methyl-2-pyrrolidinone, triethylamine, diethylene glycol, o-xylene, m-xylene, p-xylene, chlorobenzene, chloroform, diglyme (diethylene glycol dimethyl ether), hexamethylphosphorous triamide, hexamethylphosphoramide, or combinations thereof.

15. The process of claim 1, further comprising mixing, at a first time, the sol-gel with a first base catalyst.

16. The process of claim 15, wherein the first base catalyst comprises an organosilane compound.

17. The process of claim 15, further comprising mixing, at a second time, the sol-gel with a first acid catalyst.

18. The process of claim 17, wherein the first acid catalyst comprises nitric acid, sulfuric acid, sulfurous acid, phosphoric acid, carbonic acid, hydrochloric acid, or combinations thereof.

19. The process of claim 17, further comprising:
increasing the pH of the solution by mixing, at a third time, the sol-gel with a second base catalyst; and
decreasing the pH of the solution by mixing, at a fourth time, the sol-gel with a second acid catalyst.

20. The process of claim 19, further comprising exchanging the solution with an organic solvent.
